(19) United States
(12) Patent Application Publication
(10) Pub. No.: US 2019/0066118 A1
(43) Pub. Date: Feb. 28, 2019

(54) COMPUTER AND INFORMATION PROCESSING METHOD

(71) Applicant: Mitsunori HIRATA, Nara (JP)

(72) Inventor: Mitsunori HIRATA, Yamatotakada-shi (JP)

(21) Appl. No.: 16/081,451

(22) PCT Filed: Mar. 15, 2016
(86) PCT No.: PCT/JP2016/058089

§ 371 Date: Aug. 31, 2018

(51) Int. Cl. G06Q 30/00; G06F 17/30; G06Q 30/02; G06Q 10/10

(52) U.S. Cl. CPC G06Q 30/016; G06F 17/30887; G06Q 10/107; G06Q 30/0241; G06F 17/3089

(57) ABSTRACT

Provided herein are a computer and an information processing method that can reduce the load on a call center by a larger margin than previously achieved. A computer 100 is provided that includes a processor 110. The processor 110, as a response to an inquiry, provides an address of a web page by using information regarding the inquiry. An information processing method is provided that includes receiving information regarding an inquiry, and providing an address of a web page as a response to the inquiry.

### TECHNICAL FIELD

The present invention relates to a technology related to a computer and an information processing method that enable efficient call-center operation.

### BACKGROUND ART

Various techniques are proposed that reduce the load on a call center. For example, JP-A-2010-239353 (PTL 1) discloses a sorting system and a program. The sorting system disclosed in PTL 1 includes: a load determining section for determining, on a per-inquiry basis, a predicted load on an operator with regard to an inquiry to be responded to by the operator; a status determining section for determining, on a per-operator basis, a load status with regard to a load put on an operator by an inquiry responded to by the operator; a setting section for setting, on a per-operator basis, an upper limit for an operator according to the load status of the operator with regard to a predicted load on the operator by future inquiries; and a sorting section for sorting a newly received inquiry to an operator having an upper limit above the predicted load for the inquiry.

### CITATION LIST

### Patent Literature

PTL 1: JP-A-2010-239353

### SUMMARY OF INVENTION

### Technical Problem

There is a need for a technique that reduces the load on a call center by a larger margin than previously achieved. The present invention has been made to find a solution to problems of related art, and an object of the present invention is to provide a computer and an information processing method that can reduce the load on a call center by a larger margin than previously achieved.

### Solution to Problem

According to an aspect of the invention, there is provided a computer system that includes a processor. The processor, as a response to an inquiry, provides an address of a web page by using information regarding the inquiry.

Preferably, the inquiry is made to a call center via a phone call.

Preferably, the inquiry is made via an e-mail.

Preferably, the computer system further includes a communication interface. The processor, as a response to the inquiry, directly or indirectly sends the address of the web page to the user via the communication interface.

Preferably, the processor, as a response to the inquiry made by a phone call or a mail to the call center, sends an SMS message or an e-mail containing the address of the web page, via the communication interface.

Preferably, the processor outputs information notifying the user that points will be given to the user upon browsing the web page for a response.

Preferably, the processor encourages the user making an inquiry to the call center via a phone call or a mail to provide information for identifying the user, and uses the information to give points.

Preferably, the web page is a page that displays a video as a response to the inquiry.

Preferably, the web page contains an advertisement.

According another aspect of the invention, there is provided an information processing method for a computer that includes a processor. The information processing method includes:

the processor receiving information regarding an inquiry; and

the processor providing an address of a web page as a response to the inquiry.

### Advantageous Effects of Invention

As stated above, the invention has provided a computer and an information processing method that can reduce the load on a call center by a larger margin than previously achieved.

### BRIEF DESCRIPTION OF THE DRAWINGS

FIG. 1 is a schematic diagram representing an overall configuration of a network system 1 according to First Embodiment, and a first brief overview of its operation.

FIG. 2 is a schematic diagram representing an overall configuration of the network system 1 according to First Embodiment, and a second brief overview of its operation.

FIG. 3 is a block diagram representing a hardware configuration of an interactive voice response 100 according to First Embodiment.

FIG. 4 is a schematic diagram representing a user database 121 according to First Embodiment.

FIG. 5 is a flowchart representing an information process in the interactive voice response 100 according to First Embodiment.

FIG. 6 is a block diagram representing a hardware configuration of a web server 200 according to First Embodiment.

FIG. 7 is a block diagram representing a hardware configuration of a smartphone 300 as a user terminal according to First Embodiment.

FIG. 8 is a schematic diagram representing an overall configuration of a network system 1 according to Fifth Embodiment, and a first brief overview of its operation.

FIG. 9 is a schematic diagram representing an overall configuration of the network system 1 according to Fifth Embodiment, and a second brief overview of its operation.

### DESCRIPTION OF EMBODIMENTS

Embodiments of the present invention are described below with reference to the accompanying drawings. In the following descriptions, like elements are given like reference numerals. Such like elements will be referred to by the same names, and have the same functions. Accordingly, detailed descriptions of such elements will not be repeated.

### First Embodiment

### Overall Configuration of Network System, and Brief Overview of Operation

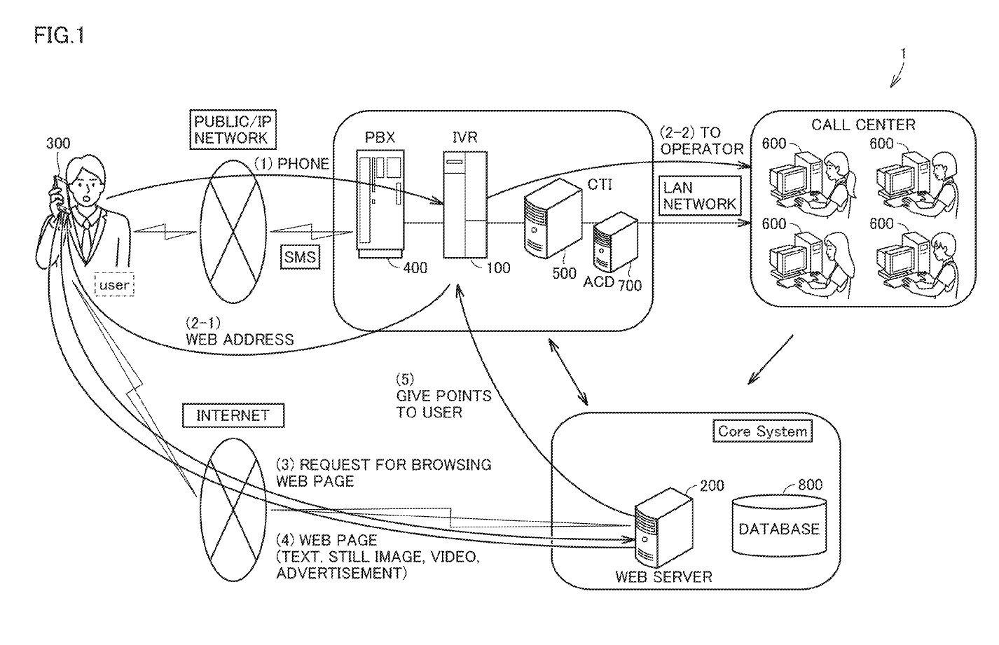

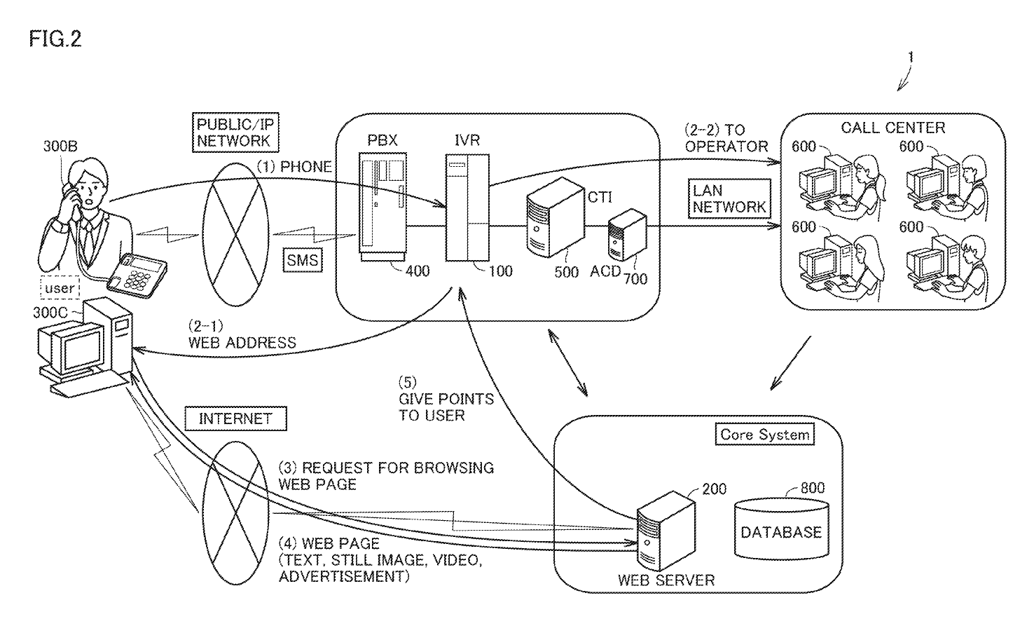

The following describes an overall configuration of a network system 1 according to the present embodiment, and a brief overview of its operation. FIG. 1 is a first schematic diagram representing an overall configuration of the network system 1 according to the present embodiment, and a brief overview of its operation. FIG. 2 is a second schematic diagram representing an overall configuration of the network system 1 according to the present embodiment, and a brief overview of its operation.

Referring to FIG. 1, the network system 1 according to the present embodiment mainly includes a private branch exchange 400 that receives a phone call to a call center; a web server 200 that provides a web page in response to a request from a user terminal 300; an interactive voice response 100 that receives a phone call to the call center via the private branch exchange 400; a CTI (Computer Telephony Integration) unit 500 that receives a phone call to the call center via the interactive voice response 100; and operator terminals 600 in the call center. The CTI unit 500 may be connected to the operator terminals 600 via an ACD (Automatic Call Distributor) 700, or may include functions of the ACD and the IVR 100.

Referring to FIG. 1, the following briefly describes the operation of when a user has made an inquiry phone call to the call center using a smartphone 300.

(1) A user makes an inquiry phone call to the call center using a smartphone 300. The private branch exchange 400 connects the phone call to the interactive voice response 100. In response to the phone call, the interactive voice response 100 outputs a voice guidance to the smartphone 300.

In the present embodiment, the interactive voice response 100 sends a voice message that tells a user to push dial numbers corresponding to different inquiries. The interactive voice response 100 then receives the user input specifying the type of inquiry.

Specifically, in the present embodiment, the interactive voice response 100 sends a voice message to the smartphone 300 that a web page that answers the selected inquiry is available, along with a voice message telling a dial number to be entered to browse the web page. Preferably, the interactive voice response 100 also sends a message to the user of the smartphone 300 that points will be given upon browsing the web page for a response.

(2-1) If the user of the smartphone 300 has chosen to browse the web page, the interactive voice response 100 sends the address of the prepared web page to the smartphone 300 through an SMS message, and ends the phone call, according to the number pushed by the user of the smartphone 300, or, to be more specific, the type of inquiry. More specifically, the interactive voice response 100 may send the message by means other than an SMS message when the address of the web page can be sent to the user via non-SMS messages, for example, such as ordinary e-mails and SNS messages, using the identification information of the smartphone 300. Preferably, the interactive voice response 100 gives points to the user by using the user's phone number.

(2-2) If the user of the smartphone 300 did not choose to browse the web page, the interactive voice response 100 connects the phone call to the CTI unit 500. The CTI unit 500 connects the user's phone call to the phone of any available operator, or, if busy, any of the operators as it becomes available, via the ACD.

(3) The user of the smartphone 300 selects the address linked in the SMS message, and requests the web server 200 for browsing of the web page prepared as a response.

(4) In response to the request from the smartphone 300, the web server 200 downloads the web page to the smartphone 300. Preferably, the web page is a page that displays a video as a response. Preferably, the web page displays, for example, an advertisement that varies with the points given to the user, before starting the video as a response to the inquiry.

Preferably, the web server 200 receives user's identification (ID) information from the user when the user browses the web page, without giving points in (2-1). (5) The web server 200 may then send the user's ID information to the interactive voice response 100, together with the points to be given to the user. More specifically, preferably, the identification of the user having made a phone cell to the call center is stored, and points are given to the user when the user has actually accessed the web page.

Referring to FIG. 2, the following briefly describes the operation of when a user has made an inquiry phone call to the call center using other types of cell phones, a home or office phone, or a pay phone (i.e., a user terminal with no function to receive an SMS message, an e-mail, or an SNS message through its phone number). In the following, other types of cell phones, home or office phones, and pay phones will be collectively referred to as ordinary phone 300B.

(1) A user makes an inquiry phone call to the call center using an ordinary phone 300B. The private branch exchange 400 connects the phone call to the interactive voice response 100. In response to the phone call, the interactive voice response 100 outputs a voice guidance to the ordinary phone 300B, as in the foregoing example.

(2-2) If the user of the ordinary phone 300B did not choose to browse the web page, the interactive voice response 100 connects the phone call to the CTI unit 500. The CTI unit 500 connects the user's phone call to the phone of any available operator, or, if busy, any of the operators as it becomes available, via the ACD.

(2-1) If the user of the ordinary phone 300B has chosen to browse the web page, the interactive voice response 100 informs the user that his or her phone is not SMS compatible, and asks the user of the ordinary phone 300B to enter a user ID, or a phone number or a mail address that can accept an SMS message. The interactive voice response 100 then sends the web page address to the user's mail address, and ends the phone call. More specifically, the interactive voice response 100 is storing user information such as user IDs, phone numbers, and mail addresses so that the user browsing the web page can be identified. The user identification information may be information received solely through the user's terminal, or through voice recognition by means of sound, or may be obtained by using a phone number recognition function. Alternatively, the user may be specified using database.

(3) By using the received address, the user of the ordinary phone 300B requests the web server 200 for browsing of the web page prepared as a response, using a personal computer 300C.

(4) In response to the request from the personal computer 300C, the web server 200 downloads the web page to the smartphone 300. Here, the web server 200 receives user identification information from the user.

(5) The web server 200 sends the user identification information to the interactive voice response 100, together with the points to be given to the user.

As described above, in the present embodiment, a user that has made an inquiry to the call center can be directed to a web page, and the load on the call center can be reduced by a larger margin than previously achieved. For example, the call center can operate with fewer operators and with fewer operator terminals. Particularly, in the present embodiment, a user is told that points will be given, or points are actually given to a user. This more encourages the user to browse a web page for a response than previously achieved. Because the response page shows advertisements, the operator of the computer system can earn advertising revenue in exchange for the points given to the user. That is, the user can earn points, and the company receiving inquiries can earn advertising revenue while reducing the load on its call center.

The following describes a specific configuration of the network system 1 that achieves these functions. It is to be noted that common members such as the private branch exchange 400, the CTI unit 500, and the operator terminal 600 have the same configurations and functions as those commonly used in the art, and will not be described.

### Hardware Configuration of Interactive Voice Response 100

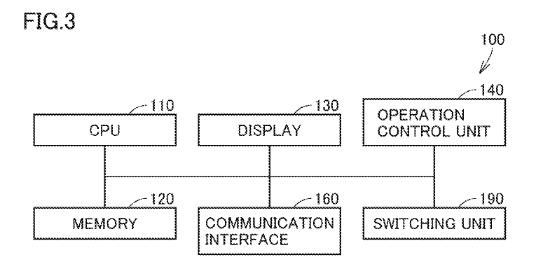

An aspect of the hardware configuration of the interactive voice response 100 constituting the network system 1 is described below. FIG. 3 is a block diagram representing a hardware configuration of the interactive voice response 100 according to the present embodiment.

Referring to FIG. 3, the main constituting elements of the interactive voice response 100 include a CPU (Central Processing Unit) 110, a memory 120, a display 130, an operation control unit 140, a communication interface 160, and a call switching unit 190.

The CPU 110 controls different parts of the interactive voice response 100 by executing the programs stored in the memory 120. Specifically, the CPU 110 executes the programs stored in the memory 120, and performs various processes (described later) by referring to various data.

The memory 120 is realized by various types of memory, including, for example, RAM (Random Access Memory), ROM (Read-Only Memory), and flash memory. The memory 120 also can be realized by storage media used via interfaces, for example, such as USB® (Universal Serial Bus) memory, CD (Compact Disc), DVD (Digital Versatile Disk), memory cards, hard disks, IC (Integrated Circuit) cards, optical memory cards, mask ROM, EPROM (Erasable Programmable Read Only Memory), and EEPROM (Electronically Erasable Programmable Read-Only Memory).

The memory 120 stores, for example, programs executed by the CPU 110, data generated by execution of programs by the CPU 110, input data, and databases used for services according to the present embodiment. For example, the memory 120 stores a user database 121.

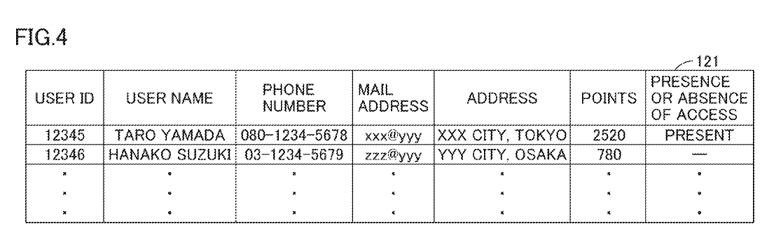

FIG. 4 is a schematic diagram representing the user database 121 according to the present embodiment. Referring to FIG. 4, the user database 121 stores user IDs, user names, phone numbers, e-mail addresses, addresses, points having currency value to pay for goods and services, and flags indicating that a phone call has been made to a call center, or that a user has chosen to browse a web page for a response, instead of talking to an operator in the call center. These are stored for each user registered in various services.

Referring back to FIG. 3, the display 130 outputs texts and images, based on signals from the CPU 110. The operation control unit 140 receives instructions from the operator of the inquiry service, and inputs the instructions to the CPU 110.

The communication interface 160 sends data from the CPU 110 to other devices such as a user terminal and the web server 200 via, for example, the Internet and routers. Conversely, the communication interface 160 receives data from other devices such as a user terminal and the web server 200 via, for example, the Internet and routers, and passes the data to the CPU 110.

The switching unit 190 outputs sound to the smartphone 300 and the ordinary phone 300B, based on signals from the CPU 110.

### Information Process in Interactive Voice Response 100

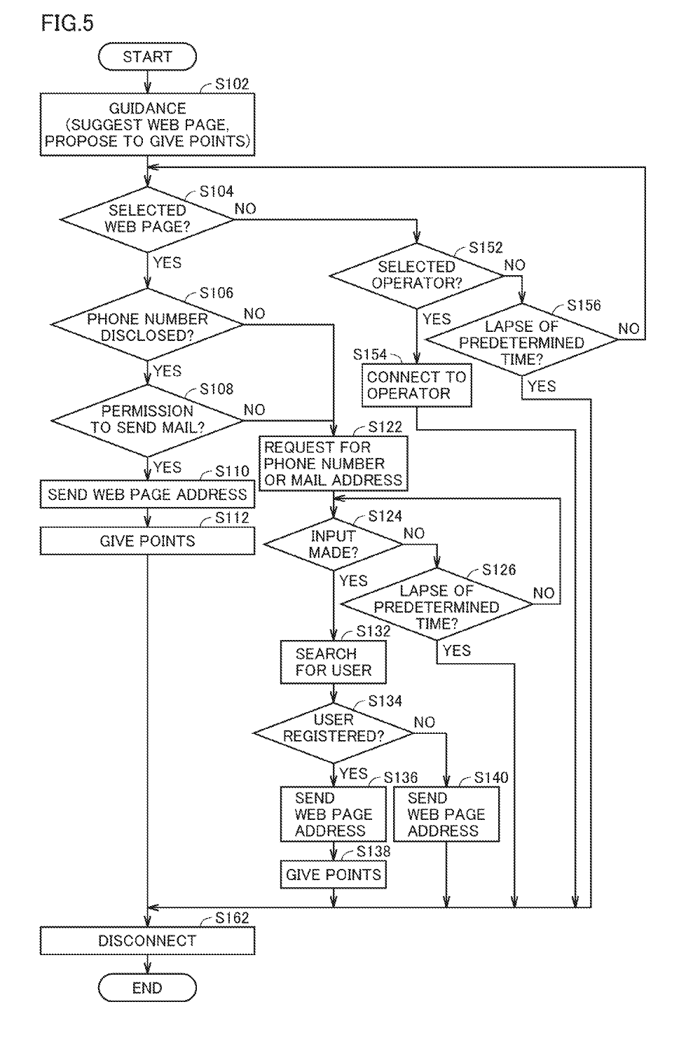

Referring to FIG. 5, the following describes the information process in the interactive voice response 100 according to the present embodiment. FIG. 5 is a flowchart representing the information process in the interactive voice response 100 according to the present embodiment.

In response to a phone call, the CPU 110 of the interactive voice response 100 performs the following processes. The CPU 110 switches lines to send a voice guidance to the caller (step S102). In the present embodiment, the descriptions provided by the guidance include a type of inquiry, dial numbers for different inquiries, availability of a web page providing a response to an inquiry, and information telling a user that points will be given upon browsing the web page.

After the input of a number specifying the type of inquiry, the CPU 110 determines whether a number button, for example, the # button, to browse a web page has been pressed (step S104). If a button to browse a web page has not been pressed (NO in step S104), the CPU 110 determines whether a button to talk to an operator has been pressed (step S152).

The CPU 110 connects the phone call to the CTI unit 500 (step S154) if a button to talk to an operator has been pressed (YES in step S152). In response, the CTI unit 500 connects the phone call to any available operator, or, if busy, any of the operators as it becomes available. The CPU 110 then puts itself in standby for future inquiry calls.

If a button to talk to an operator has not been pressed (NO in step S152), the CPU 110 determines whether a predetermined time has elapsed from when the phone call was received (step S156). The CPU 110 cuts off the phone call (step S162) if the predetermined time has elapsed from when the phone call was received (YES in step S156). The CPU 110 then puts itself in standby for future inquiry calls.

If the predetermined time has not elapsed from when the phone call was received (NO in step S156), the CPU 110 repeats the process from step S104.

If a number button to browse a web page is pressed (YES in step S104), the CPU 110 determines whether the user's phone number is disclosed (step S106). If the user's phone number is withheld (NO in step S106), the CPU 110 requests the user to enter user identification information such as a phone number, a mail address, or a user ID by sending a voice guidance that “Your phone number is blocked. Please enter the phone number or mail address of a terminal to which an SMS message or e-mail can be sent to tell you a web page address.” (step S122). The user identification information may be information received solely through the user's terminal, or through voice recognition by means of sound, or may be obtained by using a phone number recognition function. Alternatively, the user may be specified using database.

The CPU 110 determines whether a phone number or a mail address is obtained (step S124). If a phone number or a mail address is not obtained (NO in step S124), it is determined whether a predetermined time period has elapsed from when the request was made (step S126). The process from step S124 is repeated if the predetermined time period has not elapsed (NO in step S126).

The CPU 110 cuts off the call (step S162) if the predetermined time period has elapsed from when the request was made (YES in step S126). The CPU 110 then puts itself in standby for future inquiry calls.

If a phone number or a mail address is obtained (YES in step S124), the CPU 110 searches the user database 121 (step S132). If the search does not find the phone number or mail address in the user database 121 (NO in step S134), the CPU 110 sends an SMS message containing a web page address to the phone number, or sends a mail containing a web page address to the mail address (step S140). The CPU 110 then puts itself in standby for future inquiry calls.

If the search finds the phone number or mail address in the user database 121 (YES in step S134), the CPU 110 sends an SMS message containing a web page address to the phone number, or sends a mail containing a web page address to the mail address (step S136). By referring to the user database 121, the CPU 110 may give predetermined points to the user (step S138). The CPU 110 then puts itself in standby for future inquiry calls.

To describe more specifically, the process is configured preferably as follows. The CPU 110 identifies the user having made a phone call to the call center, and stores this information in the user database 121. The CPU 110 adds points to the user in the user database 121 when the user has actually accessed the web page.

Alternatively, the CPU 110 may send a login address of a response page to the user having made a phone call to the call center, and give points to the user when the user has browsed the web page by logging in. In this case, it is preferable that the CPU 110 remember the page visited by the user so that the CPU 110, by referring to this information, can prevent the same points from being given to the user twice.

If the phone number is disclosed (YES in step S106), the CPU 110 asks the user for permission to send an SMS message to the phone number (step S108). If the user rejects the request for sending an SMS message (NO in step S108), the CPU 110 requests for entry of a phone number or a mail address by sending a voice guidance that “Please enter the phone number or mail address of a terminal to which an SMS message can be sent to tell you a web page address.” (step S122). The CPU 110 then performs the process from step S124.

If the user gives permission to send an SMS message (YES in step S108), the CPU 110 sends an SMS message containing a web page address to the phone number, or sends a mail containing a web page address to the corresponding mail address (step S110). More specifically, the CPU 110 may send a web page address by means other than an SMS message when the web page address can be sent to the user via non-SMS messages, for example, such as ordinary e-mails and SNS messages, using the identification information of the smartphone 300. By referring to the user database 121, the CPU 110 may give predetermined points to the user (step S112). The CPU 110 then puts itself in standby for future inquiry calls.

In the present embodiment, an instruction regarding the decision to browse a web page is received (step S104) after receiving a number that specifies the type of inquiry. However, conversely, an instruction regarding the decision to browse a web page may be received (step S104) before receiving a number that specifies the type of inquiry.

### Hardware Configuration of Web Server 200

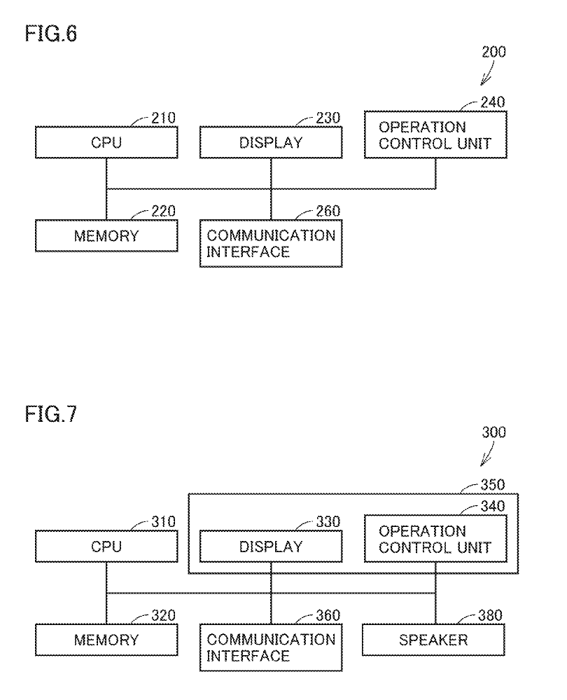

An aspect of the hardware configuration of the web server 200 constituting the network system 1 is described below. FIG. 6 is a block diagram representing a hardware configuration of the web server 200 according to the present embodiment.

Referring to FIG. 6, the main constituting elements of the web server 200 include a CPU 210, a memory 220, a display 230, an operation control unit 240, and a communication interface 260.

The CPU 210 controls different parts of the web server 200 by executing the programs stored in the memory 220. Specifically, the CPU 210 executes the programs stored in the memory 220, and performs various processes (described later) by referring to various data.

The memory 220 stores programs executed by the CPU 210, data generated by execution of programs by the CPU 210, input data, and information of web pages containing answers to inquiries used in the inquiry service according to present embodiment. The response to inquiries is not limited to texts and images, and may include video data.

The display 230 outputs texts and images based on signals from the CPU 210. The operation control unit 240 receives instructions from the operator of the inquiry service, and inputs the instructions to the CPU 210.

The communication interface 260 sends data from the CPU 210 to other devices such as a user terminal and the interactive voice response 100 via, for example, the Internet and routers. Conversely, the communication interface 260 receives data from other devices such as a user terminal and the interactive voice response 100 via, for example, the Internet and routers, and passes the data to the CPU 210.

Specifically, in the present embodiment, the CPU 210 obtains information of a web page containing answers to inquiries in response to a request from a user terminal, and downloads the information to the user terminal via the communication interface 260. The web page may contain only text, or may contain moving images and still images. For example, the CPU 210 may display the web page by showing a video at the center of the user terminal 300 with an advertisement displayed around the video, or by showing a response video after displaying a video advertisement. However, the response and advertisements may be configured from usual texts and still images. The CPU 210 may specify the user by encouraging the user to enter information such as a user ID and a phone number, and send a command to the interactive voice response 100 that points will be given to the user, via the communication interface 260.

### Hardware Configuration of User Terminal

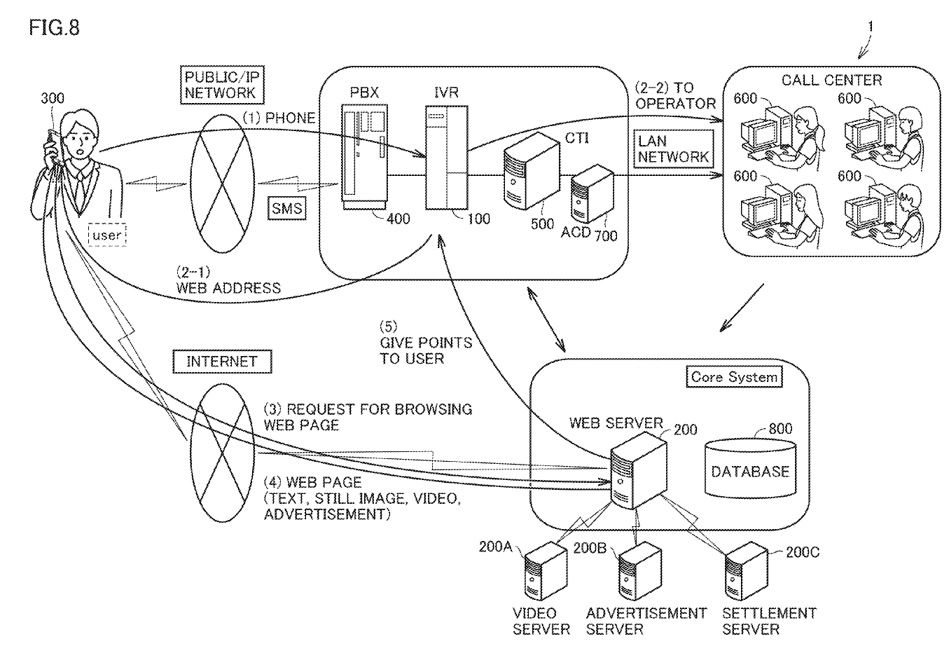

An aspect of the hardware configuration of the smartphone 300 as a user terminal constituting the network system 1 is described below. The configuration is basically the same for other types of user terminals, and the same descriptions will not be repeated. FIG. 7 is a block diagram representing a hardware configuration of the smartphone 300 as a user terminal according to the present embodiment.

Referring to FIG. 7, the main constituting elements of the smartphone 300 include a CPU 310, a memory 320, a display 330, an operation control unit 340, a communication interface 360, and a speaker 380.

The CPU 310 controls different parts of the smartphone 300 by executing the programs stored in the memory 320.

The memory 320 is realized by various types of memory, such as RAM and ROM. The memory 320 stores, for example, programs executed by the CPU 310, data generated by execution of programs by the CPU 310, data received from the interactive voice response 100 and the web server 200, input data via the operation control unit 340, and information for specifying the user of the user terminal.

The display 330 displays images and texts based on data from the CPU 310. The operation control unit 340 is configured from devices such as a pointing device and switches, and inputs various user instructions to the CPU 310. The user terminal may include a touch panel that includes the display 330 and the operation control unit 340.

The communication interface 360 sends data from the CPU 310 to other devices such as the web server 200 and the interactive voice response 100 via, for example, the Internet and routers. For example, the communication interface 360 is an interface through which a phone call is made, a mail is sent, and a web page is requested. The communication interface 360 also receives mails, texts, images, moving images, and other types of data from other devices such as the web server 200 and the interactive voice response 100 via, for example, the Internet and routers, and passes the data to the CPU 310.

The speaker 380 outputs sound according to signals from the CPU 310.

That is, the CPU 310 of the smartphone 300 downloads a web page from the web server 200, and displays texts, still images, and moving images on the display 330, and/or outputs sound from the speaker 380.

### Second Embodiment

In First Embodiment, the interactive voice response 100 controls the points given to users. However, the points given to users may be controlled by the web server 200 or some other device.

### Third Embodiment

In First Embodiment, the phone number of the smartphone 300 is registered by being associated with the user, and points are given to the user associated with the phone number if the calling phone number is disclosed. However, points may be given in a manner different from First Embodiment, as long as points are given to a user browsing a web page through a voice guidance.

It is not necessarily required that user registration is complete at the time of a phone call being made to the call center for inquiry. For example, a user may inform his or her phone number to the interactive voice response 100 when making an inquiry to the call center, and authentication may be made by asking the user to enter the phone number when browsing a web page. Alternatively, the interactive voice response 100 may issue an identification number to a user when the user has made an inquiry to the call center, and authentication may be made by asking the user to enter the identification number when browsing a web page. Points may then be given to the user upon the user completing user registration when browsing the web page.

### Fourth Embodiment

A part of the roles of the interactive voice response 100, the web server 200, or other device may be served by AI (Artificial Intelligence). A user may then input information by means of voice, in addition to, or instead of, inputting information via the operation control unit of the user terminal. In this case, any of the devices in the network system 1 may receive information from the user, using speech recognition such as that of Watson.

### Fifth Embodiment

The network systems 1 of First to Fourth Embodiments mainly include the private branch exchange 400, the user terminals 300 and 300C, the web server 200, the interactive voice response 100, and the CTI unit 500. The network system 1 may include the ACD 700 separately from the CTI unit 500. However, any of the devices may serve the functions of other devices, either in part or as a whole. Alternatively, a part of or the entire function of more than one device maybe served by a single device. For example, the CIT unit 500 may have a function of the ACD 700, and the interactive voice response 100 may have functions of the CIT unit 500 and the ACD 700. Alternatively, the function of any of these devices may be served by a plurality of devices. For example, the CTI unit 500 may be a unit that includes at least one device for outputting automated voice, and at least one device for sending a web address. The data stored in any of these devices may be stored in other devices or in a database, provided that the devices are accessible.

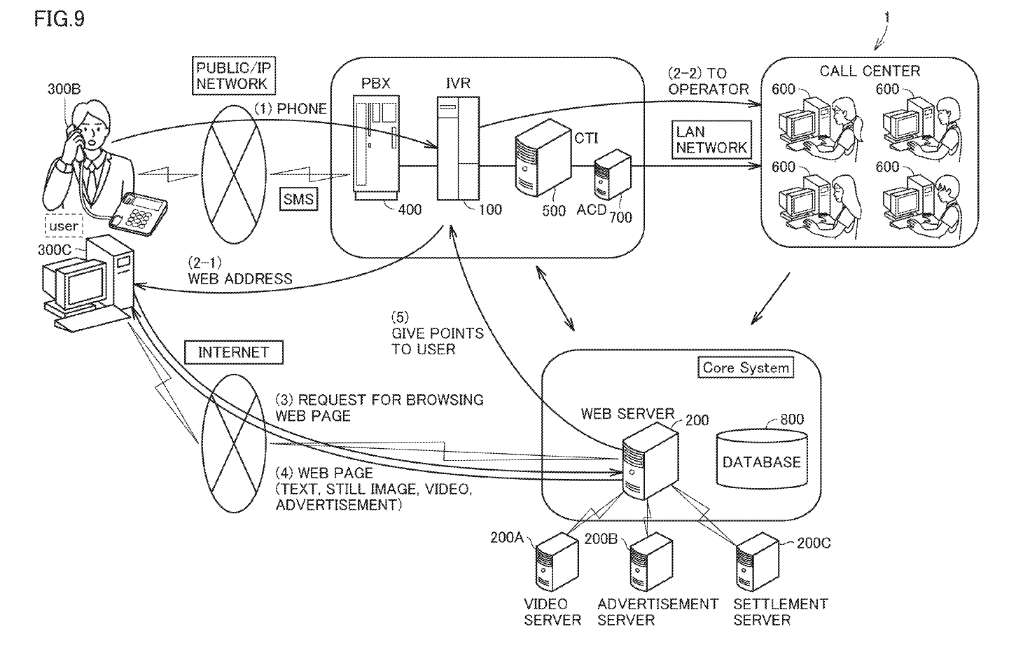

For example, a web page for displaying a video response page may be downloaded into the user terminals 300 and 300C by the web server 200 itself, or, as shown in FIGS. 8 and 9, the web server 200 may be adapted to download, for example, a video to the user terminals 300 and 300C by using data from a video server 200A. The web server 200 also may be adapted so that an advertisement video to be played before the video is downloaded to the user terminals 300 and 300C by using data from an advertisement server 200B, or an advertisement video to be displayed around the video is downloaded to the user terminals 300 and 300C by using data from the advertisement server 200B. The web server 200 also may handle points and advertising revenue via a settlement server 200C.

The present invention can provide the network system (computer system) 1 of any of these forms.

### Sixth Embodiment

A web page address may be sent via an SMS message to the user terminal having made a phone call to the call center, or may be sent to an e-mail address pre-registered by being associated with the user, or to the user's my page of any service. A web address may be sent to the address desired by the user.

### Seventh Embodiment

In First to Fifth Embodiments, the inquiry phone call to the call center is either connected to an operator, or directed to a web page without being connected to an operator. However, the invention is not limited to such an embodiment. For example, an operator connected to a user may encourage the user to browse a web page. To describe more specifically, the address of the user talking to the operator, and the content of inquiries are stored in the interactive voice response 100 or other device, and the address of a response web page corresponding to the type of the inquiry being asked is sent to the user upon the operator inputting a predetermined instruction to the operator terminal 600.

### Eighth Embodiment

In First to Sixth Embodiments, an inquiry phone call to the call center is directed to a web page. However, the invention is not limited to such an embodiment. For example, an inquiry may be accepted via an e-mail. In this case, typical phrases often contained in the texts of mails from users are stored in the memory 120 for each type of inquiry, together with the addresses of response web pages. The CPU 110 specifies a typical mail-text phrase close to the content of the e-mail received via the communication interface 160, and sends the address of a corresponding response web page to the user.

Alternatively, for example, when the operator responds to the user by sending mail, the operator may encourage the user to browse a web page by sending a mail after checking the content of the inquiry mail. Specifically, the address of the user talking to the operator via mail is stored in the interactive voice response 100 or other device, together with the content of inquiry, and the address of a response web page corresponding to the type of the inquiry being asked is sent to the user upon the operator inputting a predetermined instruction to the operator terminal 600.

### Supplementation

As is evident, the present invention also can be achieved by supplying a program to a system or a device. The advantages of the present invention also can be obtained with a computer (or a CPU or an MPU) in a system or a device upon the computer reading and executing the program code stored in the supplied storage medium (or memory) storing software programs intended to realize the present invention.

In this case, the program code itself read from the storage medium realizes the functions of the embodiments above, and the storage medium storing the program code constitutes the present invention.

Evidently, the functions of the embodiments above can be realized not only by a computer reading and executing such program code, but by some or all of the actual processes performed by the OS (operating system) or the like running on a computer under the instructions of the program code.

The functions of the embodiments above also can be realized by some or all of the actual processes performed by the CPU or the like of an expansion board or expansion unit under the instructions of the program code read from a storage medium and written into other storage medium provided in the expansion board inserted into a computer or the expansion unit connected to a computer.

### Review

The foregoing First to Eighth Embodiments provide a computer 100 that includes a processor 110. The processor 110, as a response to an inquiry, provides an address of a web page based on the inquiry.

Preferably, the inquiry is made to a call center via a phone call.

Preferably, the inquiry is made via an e-mail.

Preferably, the computer 100 further includes a communication interface 160. The processor 110, as a response to the inquiry, directly or indirectly sends the address of the web page to a user via the communication interface 160.

Preferably, the processor 110, as a response to the inquiry made by a phone call or a mail to the call center, sends an SMS message or an e-mail containing the address of the web page, via the communication interface 160.

Preferably, the processor 110 outputs information notifying the user that points will be given to the user upon browsing the web page for a response.

Preferably, the processor 110 encourages the user making an inquiry to the call center via a phone call or a mail to provide information for identifying the user, and provides the web server 200 with the information for identifying the user.

Preferably, the web page is a page that displays a video as a response to the inquiry.

Preferably, the web page contains an advertisement.

According another aspect of the invention, there is provided an information processing method for a computer 100 that includes a processor 110. The information processing method includes: the processor 110 receiving an inquiry phone call directed to a call center; and the processor 110 providing a user of the calling phone with an address of a web page as a response to the inquiry.

The embodiments disclosed herein are to be considered in all aspects only as illustrative and not restrictive. The scope of the present invention is to be determined by the scope of the appended claims, not by the foregoing descriptions, and the invention is intended to cover all modifications falling within the equivalent meaning and scope of the claims set forth below.

### REFERENCE SIGNS LIST

1: Network system
100: Interactive voice response (computer)
110: CPU (processor)
120: Memory
121: User database
130: Display
140: Operation control unit
160: Communication interface
190: Call switching unit
200: Web server
210: CPU
220: Memory
230: Display
240: Operation control unit
260: Communication interface
300: Smartphone
300B: Ordinary phone
300C: Personal computer
310: CPU
320: Memory
330: Display
340: Operation control unit
360: Communication interface
380: Speaker
400: Private branch exchange
500: CTI unit
600: Operator terminal

1. A computer system comprising a processor, wherein the processor, as a response to an inquiry, provides an address of a web page by using information regarding the inquiry.

2. The computer system according to claim 1, wherein the inquiry is made to a call center via a phone call.

3. The computer system according to claim 1, wherein the inquiry is made via an e-mail.

4. The computer system according to claim 1, which further comprises a communication interface, wherein the processor, as a response to the inquiry, directly or indirectly sends the address of the web page to the user via the communication interface.

5. The computer system according to claim 1, wherein the processor, as a response to the inquiry made by a phone call or a mail to the call center, sends an SMS message or an e-mail containing the address of the web page, via the communication interface.

6. The computer system according to claim 1, wherein the processor outputs information notifying the user that points will be given to the user upon browsing the web page for a response.

7. The computer system according to claim 6, wherein the processor encourages the user making an inquiry to the call center via a phone call or a mail to provide information for identifying the user, and uses the information to give points.

8. The computer system according to claim 1, wherein the web page is a page that displays a video as a response to the inquiry.

9. The computer system according to claim 1, wherein the web page contains an advertisement.

10. An information processing method for a computer that includes a processor,
the method comprising:
the processor receiving information regarding an inquiry; and
the processor providing an address of a web page as a response to the inquiry.
